(19) United States
(12) Patent Application Publication
(10) Pub. No.: US 2014/0087339 A1
(43) Pub. Date: Mar. 27, 2014

(54) TOILET TARGET AND REWARD APPARATUS

(71) Applicants: Holly Jo Ventle, Tulsa, OK (US); Eloise Irene Tillamn, Brooklyn, NY (US)

(72) Inventors: Holly Jo Ventle, Tulsa, OK (US); Eloise Irene Tillamn, Brooklyn, NY (US)

(21) Appl. No.: 13/624,053

(22) Filed: Sep. 21, 2012

(51) Int. Cl. G09B 19/00

(52) U.S. Cl. CPC G09B 19/0076
USPC 434/236

(57) ABSTRACT

A toilet training aide formed of a flushable, biodegradable material comprising a multi-layer pocket with a latent image revealed by locating the toilet training aide under a stream of liquid or urine, the toilet training aide further including a tab portion used to maintain the toilet training aide in a fixed position in the toilet bowl.

### CROSS-REFERENCE TO RELATED APPLICATIONS

N/A

### STATEMENT REGARDING FEDERALLY SPONSORED RESEARCH OR DEVELOPMENT.

N/A

### THE NAMES OF THE PARTIES TO A JOINT RESEARCH AGREEMENT.

N/A

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC.

N/A

### BACKGROUND

The present art relates generally to floating toilet training aides. More particularly, the present art relates to biodegradable floating toilet training aides. Current floating toilet training aides do not remain stationary when in use, thereby creating frustration and hindering toilet training efforts.

### SUMMARY

A toilet training aide formed of a flushable, biodegradable material comprising a multi-layer pocket with a latent image revealed by locating the toilet training aide under a stream of liquid or urine, the toilet training aide further including a tab portion used to maintain the toilet training aide in a fixed position in the toilet bowl.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an embodiment of the base layer.

FIG. 2 illustrates an embodiment of the unfolded pocket.

FIG. 3 illustrates an embodiment of the folded pocket affixed to the base layer.

FIG. 4 illustrates an exploded view of an embodiment of the folded pocket affixed to the base layer.

FIG. 5 illustrates an embodiment of the training aide before and after use.

### DETAILED DESCRIPTION

The embodiments discussed herein are merely illustrative of specific manners in which to make and use the claimed subject matter and are not to be interpreted as limiting the scope thereof.

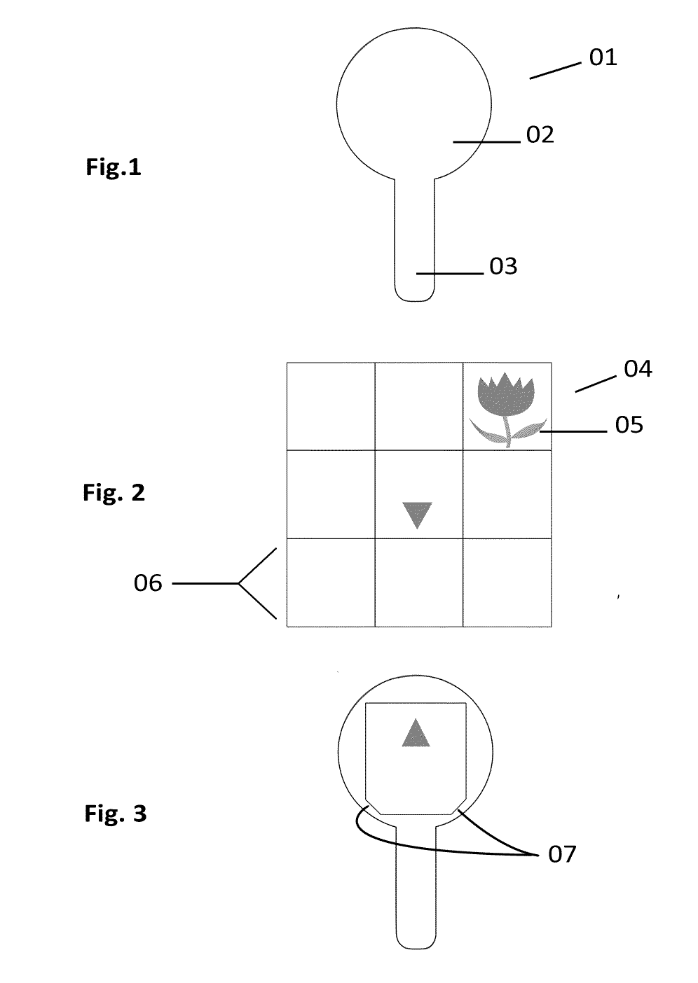

Referring to the drawings in detail, FIG. 1 illustrates an embodiment of the base layer. The base layer is preferably comprised of a single sheet of flushable biodegradable paper [01] of sufficient weight to float in water cut to form a pad area [02], used to hold the pocket, and a finger [03] protruding from the pad area, which is of sufficient length to touch the side of a toilet bowl and maintain the pad area in a relatively fixed position in the toilet bowl. The base layer may be treated with an emollient to slow liquid absorption. In the preferred embodiment, the pad area is circular in shape with a diameter of approximately 5.5 inches and the finger protruding from the pad area extends from the pad area approximately 5.5 inched and has a width of approximately 1.5 inches.

FIG. 2 illustrates an embodiment of the unfolded pocket. The unfolded pocket [04] is preferably comprised of a single sheet of flushable biodegradable paper approximately 12 inches by 12 inches square. Reward images [05] may be affixed (by adhesive, direct printing, etc.) to the paper at any desired location. In the preferred embodiment, the unfolded pocket is folded so as to create an approximately 4 inch square [06] layered pocket with latent images located on the inner layers of the paper, thereby hiding the reward images from view until the aide is used. The pocket is preferably formed by folding the top ⅓ portion of the paper over the middle ⅓ portion of the paper, the bottom ⅓ portion of the paper is then folded over creating a three layer piece of paper approximately 4 inches high by 12 inches wide. The left ⅓ of the three-layer piece of paper is folded over the middle ⅓, the right ⅓ portion of the paper is then folded over creating a nine-layer piece of paper approximately 4 inches by 4 inches. It should be noted that the number of layers between the top of the pocket and the latent reward image depends on which section of the unfolded paper the image is placed. The pocket may also be formed by stacking several sheets of paper on top of the paper containing the latent image. Apertures may be added to the paper forming the pocket to facilitate flow of liquid into the pocket and between the layers allowing for quicker reveal of the latent reward images when the aide is in use.

FIG. 3 illustrates an embodiment of the folded pocket affixed to the base layer. One image is viewable, while the reward image is hidden. In this embodiment, the pocket apertures [07] have been formed by removing corners from the pocket.

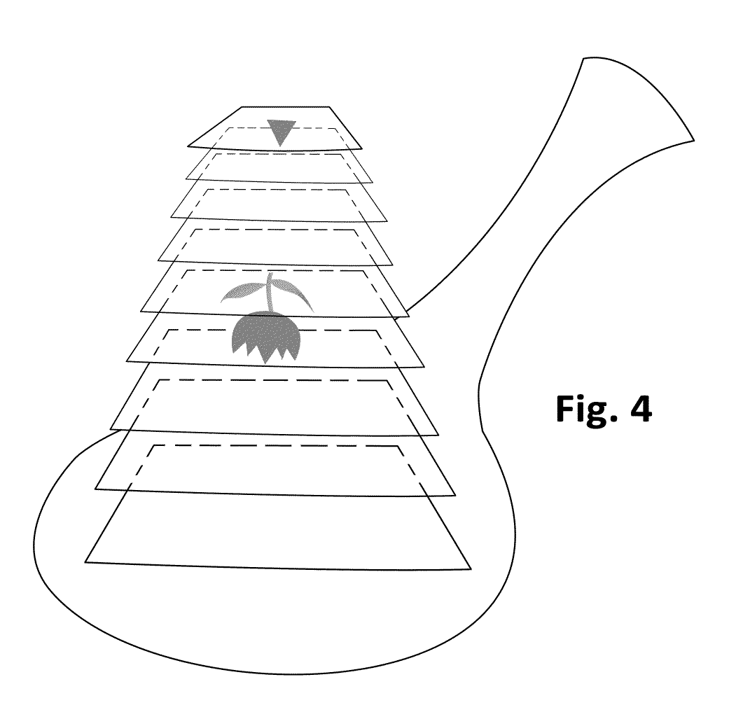

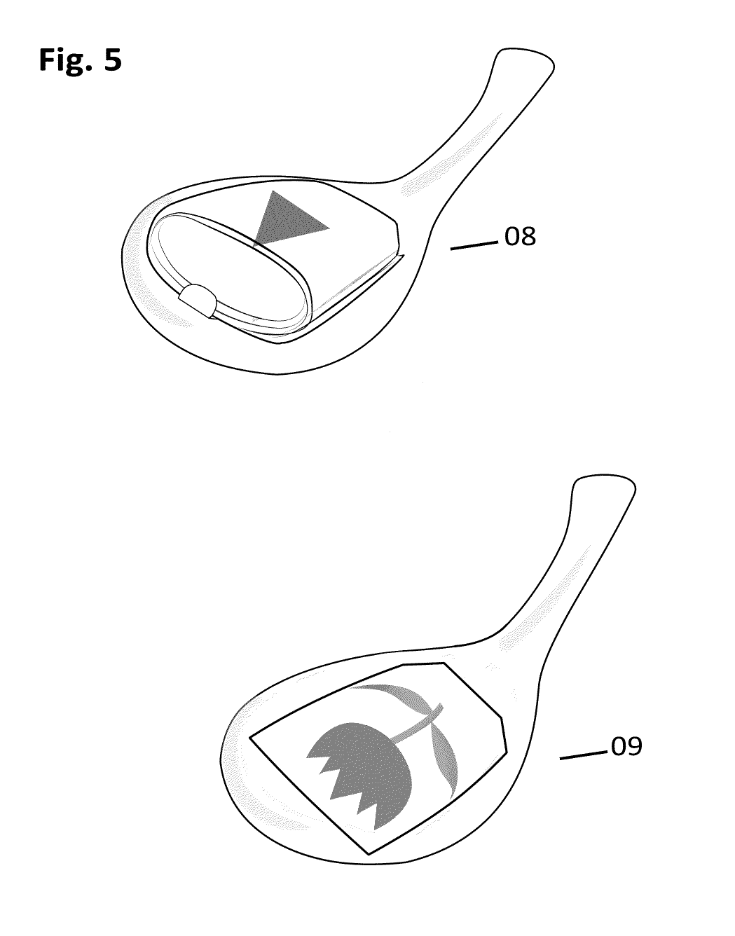

FIG. 4 illustrates an exploded view of an embodiment of the folded pocket affixed to the base layer. The pocket layers with the reward image contained therein are shown.

FIG. 5 illustrates an embodiment of the training aide before and after use. A dry training aid [08] is first placed in the toilet and the latent reward image remains hidden in the pocket layers. Once the toilet has been used and the aide has become wet [09] from the top, the latent reward image is revealed, thereby providing positive feedback to the child in training.

While the claimed subject matter has been described with a certain degree of particularity, it is to be noted that modifications may be made in the details of the claimed subject matter's construction and the arrangement of its components without departing from the spirit and scope of this disclosure. It is understood that the claimed subject matter is not limited to the embodiments set forth herein for the purposes of exemplification.

1. A toilet training aide comprising:
a. a base layer of biodegradable material;
b. a means for partially affixing said base layer to the inner portion of a toilet bowl;
c. a pocket of biodegradable material affixed to said base layer;
d. a biodegradable image contained within said pocket.

2. The toilet training aide of claim 1, wherein said base layer is chemically treated to slow liquid absorption.

3. The toilet training aide of claim 1, wherein said image is printed on said pocket.

4. The toilet training aide of claim 1, wherein said pocket is affixed to said base layer by a water-soluble adhesive.

5. The toilet training aide of claim 1, wherein said pocket is a single sheet of folded biodegradable material.

6. The toilet training aide of claim 5, wherein said single sheet of folded biodegradable material contains at least one aperture.

7. The toilet training aide of claim 1, wherein said pocket is multiple sheets of biodegradable material stacked.

8. A toilet training aide comprising:
a. a base layer of biodegradable material chemically treated to slow liquid absorption;
b. a means for partially affixing said base layer to the inner portion of a toilet bowl;
c. a pocket formed of a single sheet of biodegradable material containing at least one aperture affixed to said base layer by a water-soluble adhesive;
d. a biodegradable image printed on said pocket.

9. A toilet training aide comprising:
a. a base layer of biodegradable material chemically treated to slow liquid absorption;
b. a means for partially affixing said base layer to the inner portion of a toilet bowl;
c. a pocket formed of multiple sheets of biodegradable material stacked and affixed to said base layer by a water-soluble adhesive;
d. a biodegradable image printed on said pocket.
